(19) United States
(12) Patent Application Publication
(10) Pub. No.: US 2015/0227556 A1
(43) Pub. Date: Aug. 13, 2015

(54) INFORMATION TERMINAL DEVICE AND STORAGE SERVICE USE METHOD

(71) Applicant: FUJITSU LIMITED, Kawasaki-shi (JP)

(72) Inventors: Masatoshi Kimura, Kawasaki (JP); Shin Yamada, Shiojiri (JP); Kohichi Kasama, Shizuoka (JP); Toshiyuki Kawanishi, Kawasaki (JP)

(21) Appl. No.: 14/693,372

(22) Filed: Apr. 22, 2015

Related U.S. Application Data
(63) Continuation of application No. PCT/JP2012/077651, filed on Oct. 25, 2012.

(51) Int. Cl. G06F 17/30

(52) U.S. Cl. CPC G06F 17/30244; G06F 17/30581

(57) ABSTRACT

A PC performs full synchronization with a cloud system, whereas a smart phone performs thumbnail synchronization with the cloud system. Furthermore, when uploading a photograph to the cloud system, the PC and the smart phone create a thumbnail “medium” from the original photograph and send the thumbnail “medium” to the cloud system together with the original photograph. Furthermore, when creating the thumbnail “medium” and when one side is excessively longer than the other side, the PC and the smart phone reduce the long side to a predetermined threshold while maintaining the aspect ratio.

### CROSS-REFERENCE TO RELATED APPLICATION(S)

This application is a continuation of International Application No. PCT/JP2012/077651, filed on Oct. 25, 2012, the entire contents of which are incorporated herein by reference.

### FIELD

The embodiment discussed herein is directed to an information terminal device and a storage service use method.

### BACKGROUND

In recent years, storage services in which data, such as photographs or documents, is stored in a cloud system are provided (for example, see Non-Patent Document 1). The cloud system mentioned here is an abbreviation for a cloud computing system and, in the cloud system, users use applications or storage devices on servers via networks.

For example, a user stores photographs taken by a digital camera or a smart phone in a personal computer (PC) and also stores the photographs in a cloud system, thereby the user easily backs up the photographs.

Furthermore, data synchronization technology is developed, in which, if the data, such as photographs stored in the PC and the cloud system, is updated one of the PC and the cloud system, the data stored in the other one of the PC and the cloud system is automatically updated.

Non-Patent Document 1: “ib on the net”, [searched on Oct. 16, 2012], Internet <URL:http://www.ibonthenet.com/ns/>

The cloud system is used via various types of information terminal devices, such as PCs, smart phones, or the like. Accordingly, data synchronization is also performed between the cloud system and the various types of information terminal devices. However, for the information terminal devices with various types, the CPU performance, the communication performance, and the storage capacity differ and, in some information terminal devices, there is a problem in that a trouble occurs when data synchronization is performed with the cloud system.

For example, if data synchronization is performed in a smart phone with a storage capacity that is smaller than that of the cloud system, the smart phone is unable to store the data in the cloud system. Furthermore, if an amount of data to be synchronized is great, in an information terminal device in which the CPU performance or the communication performance is lower than that of the other information terminal devices, it takes a long time to perform a synchronization process.

### SUMMARY

According to an aspect of an embodiment, an information terminal device includes a determining unit that determines whether an own device has capability to perform data synchronization, by using original data, with a service providing apparatus that provides a storage service for storing, together with the original data, reduced data whose size is reduced to equal to or less than the size of the original data; and a synchronizing unit that performs, when the determining unit determines that the own device does not have the capability, data synchronization with the service providing apparatus by using the reduced data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating the configuration of a storage service system according to an embodiment;

FIG. 2 is a schematic diagram illustrating the configuration of a PC;

FIG. 3 is a schematic diagram illustrating the configuration of a smart phone;

FIG. 4 is a schematic diagram illustrating the configuration of a storage service using unit;

FIG. 5A is a schematic diagram illustrating data items stored in an individual management file;

FIG. 5B is a schematic diagram illustrating data items stored in the integrated management file;

FIG. 6A is a schematic diagram illustrating a screen example of a display device displayed by an editing unit when a user newly creates a note;

FIG. 6B is a schematic diagram illustrating a screen example of the display device displayed by the editing unit when a user newly creates a note;

FIG. 6C is a schematic diagram illustrating a screen example of the display device displayed by the editing unit when a user newly creates a note;

FIG. 7 is a flowchart illustrating the flow of an uploading process from a client to a cloud system;

FIG. 8 is a flowchart illustrating the flow of a login process and a process of data synchronization in detail;

FIG. 9A is a flowchart illustrating the flow of a process related to thumbnail synchronization;

FIG. 9B is a flowchart illustrating the flow of a process related to thumbnail synchronization;

FIG. 10 is a flowchart illustrating the flow of a process of creating a thumbnail “small” performed when thumbnail synchronization is performed;

FIG. 11 is a block diagram illustrating the hardware configuration of the smart phone; and

FIG. 12 is a block diagram illustrating the hardware configuration of the PC.

### DESCRIPTION OF EMBODIMENT(S)

Preferred embodiments of the present invention will be explained with reference to accompanying drawings. The disclosed technology is not limited to the embodiment.

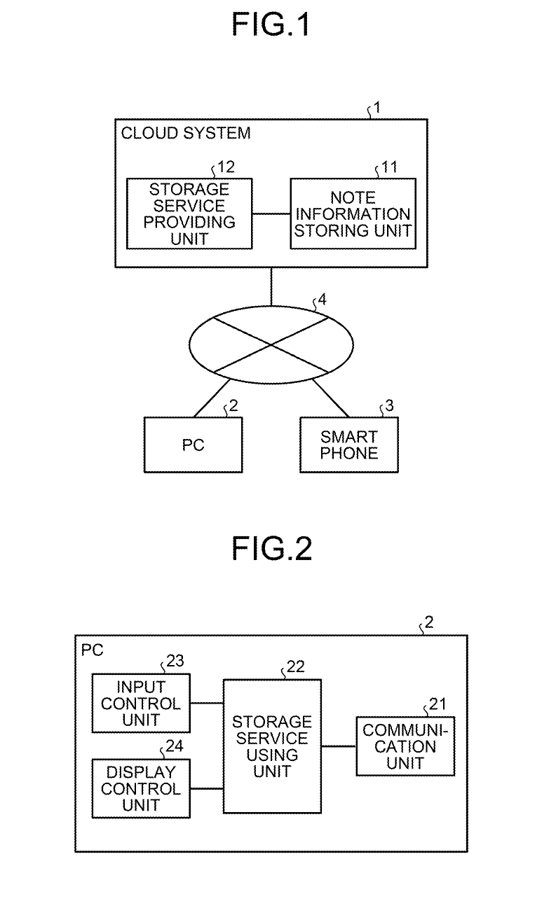

First, the configuration of a storage service system according to an embodiment will be described. FIG. 1 is a schematic diagram illustrating the configuration of a storage service system according to an embodiment. As illustrated in FIG. 1, the storage service system has the configuration in which a PC 2 and a smart phone 3 are connected to a cloud system 1 via the Internet 4.

In a description below, for convenience of description, only the single PC 2 and the smart phone 3 are illustrated; however, in some cases, the storage service system includes a large number of the PCs 2 and the smart phones 3. Furthermore, in some cases, the storage service system includes another type of information terminal device, such as a tablet type computer, a mobile phone, or the like.

The cloud system 1 provides services for storing photographs, WEB information, music, documents, or the like to users via the Internet 4. In below, a description will be given of a case in which photographs are mainly stored.

The cloud system 1 includes a note information storing unit 11 and a storage service providing unit 12. The note information storing unit 11 stores therein information related to notes and stores, for each note, information that is used to manage the note as an individual management file.

The note mentioned here is a note in which a title and comments are added to a photograph and the cloud system 1 manages the photograph as a note. Accordingly, the information related to a note includes therein a photograph file that stores therein photograph data, a title file that stores therein the title and a comment file that stores therein comments.

Furthermore, tag information is attached to a note and the tag information is also included in the information related to the note. An example of the tag information includes information indicating whether the target to be stored is a photograph, a WEB scrap, a file, or the like. Furthermore, a user can add arbitrary information as tag information. Furthermore, the title, the comments, and the tag information are used to search for a photograph. A description of the individual management file in detail will be described later.

The storage service providing unit 12 provides a storage service to a user by using the note information storing unit 11. The user accesses the cloud system 1 from the PC 2 or the smart phone 3 via the Internet 4 and uses a storage service.

Between the PC 2 and the cloud system 1, full synchronization is performed, whereas, between the smart phone 3 and the cloud system 1, thumbnail synchronization is essentially performed. The full synchronization mentioned here means that, between the cloud system 1 and the PC 2, data synchronization is performed by using the original data of the photograph. In contrast, the thumbnail synchronization mentioned here means that, between the cloud system 1 and the smart phone 3, data synchronization is performed by using thumbnail data created from photographs.

Accordingly, when a photograph is uploaded to the cloud system 1, the PC 2 and the smart phone 3 create a thumbnail from the photograph and send, to the cloud system 1, thumbnail data together with the original data of the photograph.

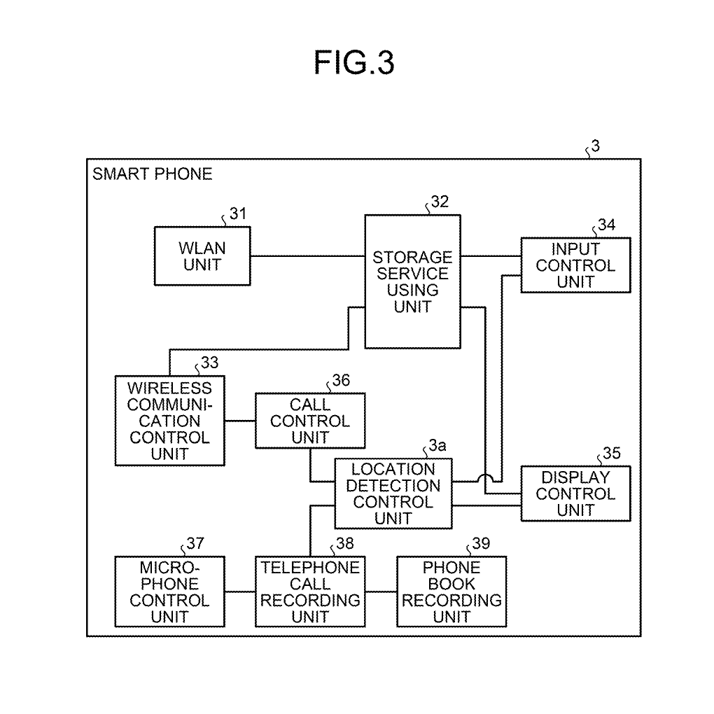

In the following, the configuration of the PC 2 and the smart phone 3 will be described. FIG. 2 is a schematic diagram illustrating the configuration of the PC 2. FIG. 3 is a schematic diagram illustrating the configuration of a smart phone 3. As illustrated in FIG. 2, the PC 2 includes a communication unit 21, a storage service using unit 22, an input control unit 23, and a display control unit 24.

The communication unit 21 performs communication with the cloud system 1 via the Internet 4. The storage service using unit 22 performs a process needed by a user to use, from the PC 2, a storage service provided by the cloud system 1. The storage service using unit 22 will be described later in detail.

The input control unit 23 receives data that is input by a user by using an input device, such as a mouse, a keyboard, or the like and gives the received data to the storage service using unit 22 or the like. The display control unit 24 displays a screen displayed by the storage service using unit 22 or the like on a display device.

As illustrated in FIG. 3, the smart phone 3 includes a WLAN unit 31, a storage service using unit 32, a wireless communication control unit 33, an input control unit 34, a display control unit 35, a call control unit 36, a microphone control unit 37, a telephone call recording unit 38, a phone book recording unit 39, and a location detection control unit 3a.

The WLAN unit 31 performs communication with the cloud system 1 via the Internet 4 by performing communication with an access point by using a wireless LAN. The storage service using unit 32 performs a process needed by a user to use, from the smart phone 3, the storage service provided by the cloud system 1. The storage service using unit 32 will be described in detail later.

The wireless communication control unit 33 performs wireless voice communication or data communication with another smart phone, a mobile phone, a fixed line phone, a computer set up by a mobile phone service provider, or the like. The input control unit 34 receives an instruction or data that is input by a user from a screen of the display device and gives the received instruction or the data to the storage service using unit 32 or the like. The display control unit 35 displays the screen displayed by the storage service using unit 32 or the like on the display device.

The call control unit 36 performs control of a telephone connection, a release, monitoring, or the like. The microphone control unit 37 performs control of a microphone that is used for a telephone call and the telephone call recording unit 38 records the telephone call. The phone book recording unit 39 manages a phone book and the location detection control unit 3a performs control of detecting the location of the smart phone 3.

In the following, the configuration of the storage service using units 22 and 32 will be described. Because the storage service using units 22 and 32 have the same configuration; therefore, in a description below, the storage service using unit 32 will be described as an example.

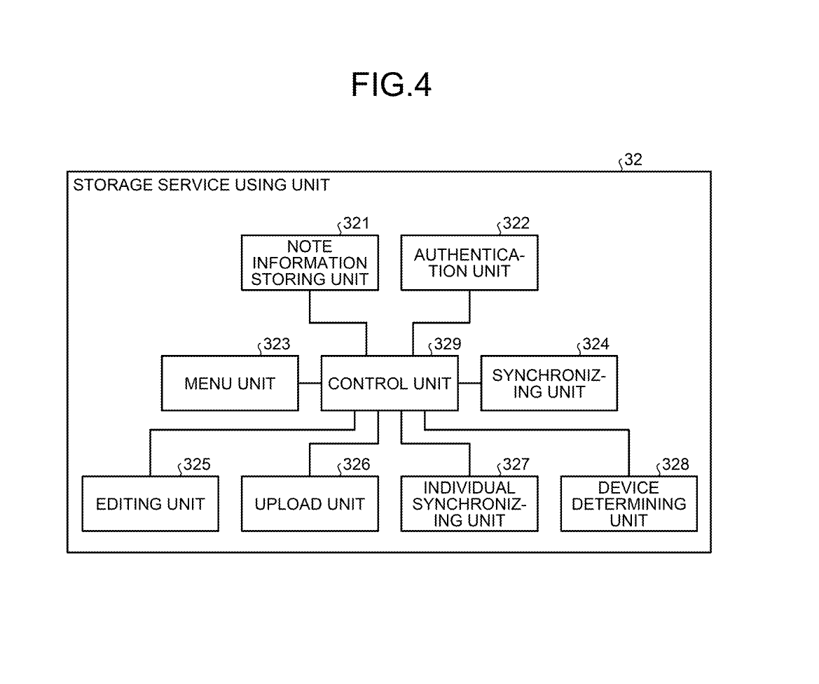

FIG. 4 is a schematic diagram illustrating the configuration of the storage service using unit 32. As illustrated in FIG. 4, the storage service using unit 32 includes a note information storing unit 321, an authentication unit 322, a menu unit 323, a synchronizing unit 324, an editing unit 325, an upload unit 326, an individual synchronizing unit 327, a device determining unit 328, and a control unit 329.

The note information storing unit 321 stores therein information on notes and stores therein, for each note, information that is used to manage the note as an individual management file. Here, for photograph data from among the pieces of the information on the note, the PC 2 stores therein the original photograph data and the smart phone 3 stores therein thumbnail data created from the original photograph data.

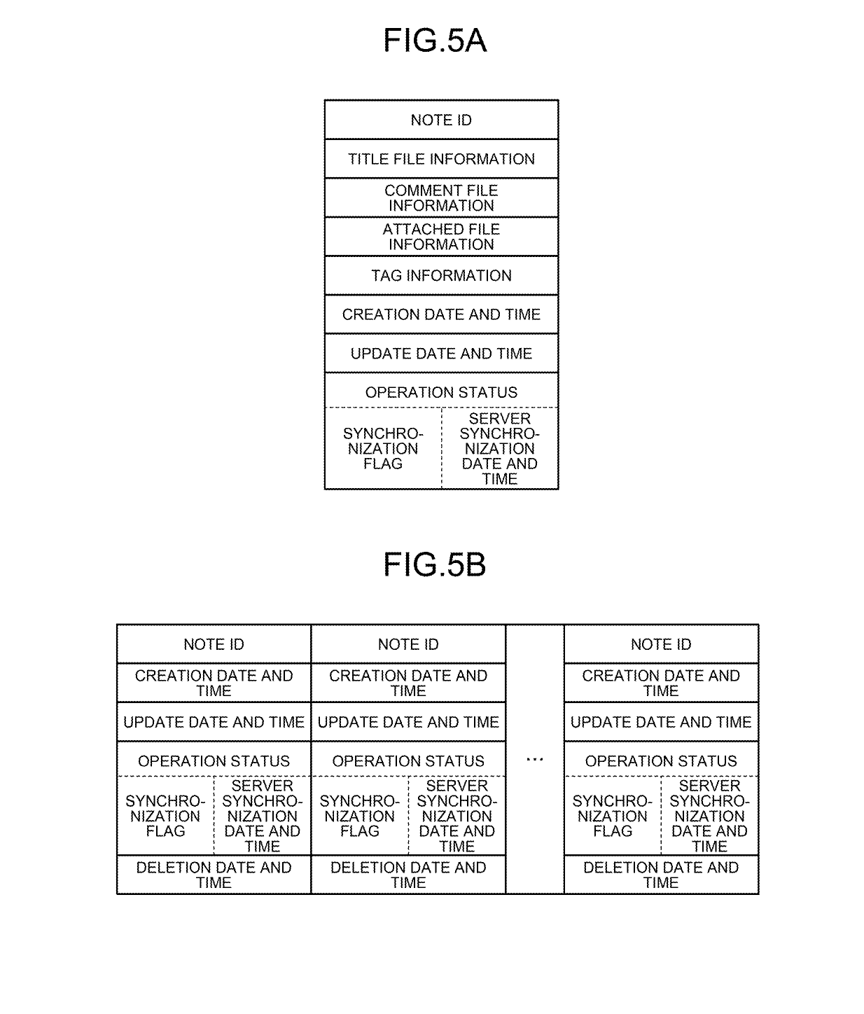

FIG. 5A is a schematic diagram illustrating data items stored in an individual management file. As illustrated in FIG. 5A, the data item stored in the individual management file includes therein a note ID, which is used to identify each note, and title file information, which is the information related to a title file that stores therein the title added to a photograph.

Furthermore, the data item stored in the individual management file includes therein comment file information that is the information related to a comment file that stores therein a comment added to a photograph; attached file information that is the information related to a file that stores therein photograph data; and tag information.

Furthermore, the data item stored in the individual management file includes therein the creation date and time of a note; the update date and time of the note; and an operation status as information related to data synchronization of a note. The operation status includes therein a synchronization flag, which indicates whether a note has been subjected to synchronization or the note has not been subjected to synchronization, and server synchronization date and time, which indicates the synchronization date and time at the server running as the storage service providing unit 12 in the cloud system 1. The individual management file is uploaded to the cloud system 1 together with the information related to the note and is stored in the note information storing unit 11.

Furthermore, the note information storing unit 321 stores therein an integrated management file in which a plurality of individual management files are integrated. FIG. 5B is a schematic diagram illustrating data items stored in the integrated management file. As illustrated in FIG. 5B, the data item stored in the integrated management file includes therein, for each note, the note ID; the creation date and time of a note; the update date and time; and an operation status. Furthermore, the data item stored in the integrated management file includes therein, for each note, the deletion date and time that indicates the date and time at which a note is deleted.

The authentication unit 322 performs user authentication. Specifically, the authentication unit 322 displays a login screen on a display device; receives, from a user, the user ID and a password for identifying the user; and determines whether the user is permitted to use the storage service. If the user is permitted to use the storage service, the authentication unit 322 allows the user to use the storage service, whereas, if not, the authentication unit 322 outputs an error message.

The menu unit 323 displays a home screen for a user to use the storage service on the display device and gives, in response to an instruction from the user, the instruction to the control unit 329. An example of the instruction from the user includes an editing instruction of a note, an upload instruction of a note, or the like.

The synchronizing unit 324 performs data synchronization with the cloud system 1. Specifically, by using the individual management file and the integrated management file stored in the note information storing unit 321 and by using the individual management file stored in the cloud system 1, the synchronizing unit 324 updates the information related to all of the notes stored in the note information storing unit 321 to the latest information.

At this time, the synchronizing unit in the PC 2 performs full synchronization, whereas the synchronizing unit 324 in the smart phone 3 performs thumbnail synchronization. The synchronizing unit 324 in the smart phone 3 performs the thumbnail synchronization, thereby the synchronizing unit 324 can suppress the occurrence of a problem in the data synchronization with the cloud system 1.

Furthermore, the synchronizing unit 324 in the smart phone 3 creates, from the thumbnail that has been subjected to the data synchronization, a thumbnail smaller than the thumbnail and stores the created thumbnail in a nonvolatile storage device. In this example, in order to distinguish two types of thumbnails, the thumbnail that is used in the thumbnail synchronization is referred to as a thumbnail “medium”, whereas the thumbnail that is created from the thumbnail “medium” and that is smaller than the thumbnail “medium” is referred to as a thumbnail “small”.

Furthermore, if the synchronizing unit 324 determines that the note stored in the cloud system 1 is newer than the note stored in the note information storing unit 321, the synchronizing unit 324 backs up the note stored in the note information storing unit 321. By backing up the note stored in the note information storing unit 321, the synchronizing unit 324 can prevent the note that is being updated from being discarded.

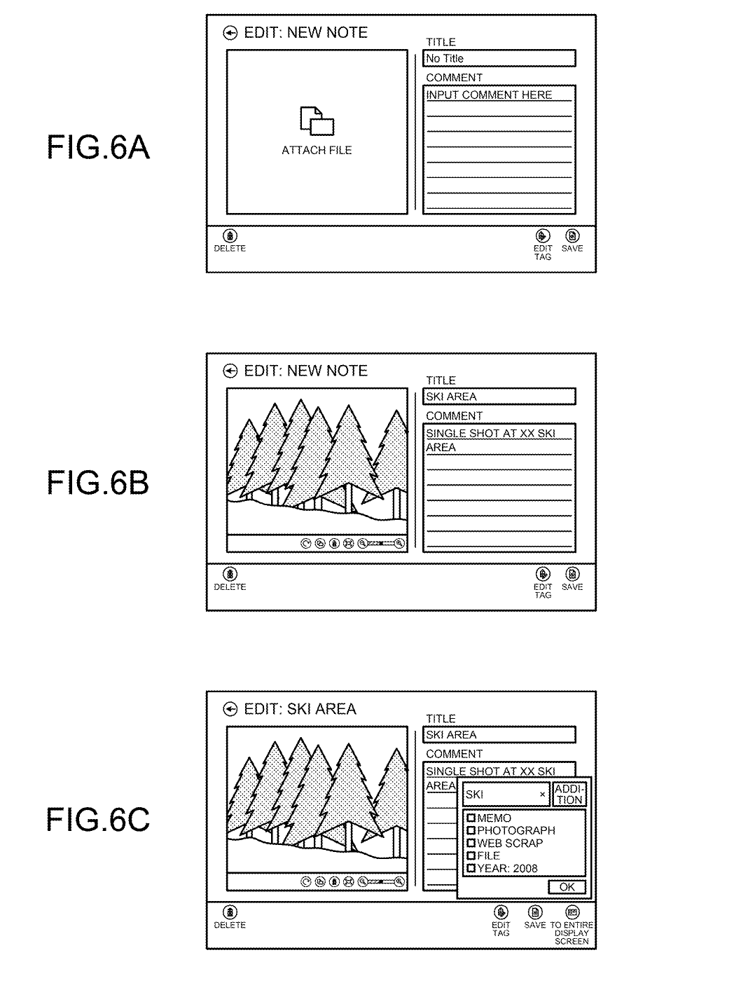

The editing unit 325 creates, updates, and deletes a note on the basis of an instruction from a user. FIGS. 6A to 6C are schematic diagrams each illustrating a screen example of a display device displayed by the editing unit 325 when a user newly creates a note.

FIG. 6A illustrates an example of an entry screen when a user newly creates a note. FIG. 6B illustrates a screen obtained after an input is entered by the user. From the entry screen illustrated in FIG. 6A, the user inputs the title and a comment and attaches a photograph file that stores therein data on a photograph, thereby the user easily creates the note and displays the note on the screen illustrated in FIG. 6B.

FIG. 6C illustrates a screen example obtained when a user adds tag information to a newly created note. In this screen example, a user adds tag information represented by “ski”.

The upload unit 326 sends, to the cloud system 1, information on the note created or updated by the editing unit 325. Furthermore, the upload unit 326 creates a thumbnail “medium” from the original photograph and sends the data on the thumbnail “medium” to the cloud system 1.

At this time, when the upload unit 326 creates the thumbnail “medium”, the upload unit 326 reduces the short side of a photograph to 450 pixels while maintaining the aspect ratio of the photograph and determines whether the long side of the photograph is equal to or less than 1024 pixels. If the determination result indicates that the long side of the photograph is equal to or less than 1024 pixels, the upload unit 326 sets, as the thumbnail “medium”, the photograph whose short side is reduced to 450 pixels. In contrast, if the long side is not equal to or less than 1024 pixels, the upload unit 326 sets, as the thumbnail “medium”, the photograph whose long side is reduced to 1024 pixels while maintaining the aspect ratio of the photograph.

In this way, when creating the thumbnail “medium”, if the long side of the thumbnail “medium” is not equal to or less than 1024 pixels, the upload unit 326 reduces the long side to 1024 pixels while maintaining the aspect ratio. Consequently, the upload unit 326 can create a thumbnail in an appropriate size even if the long side is excessively longer than the short side. The thresholds 1024 and 450 that are used when the thumbnail “medium” is created are only examples and other values may also be used as the thresholds.

Furthermore, for the thumbnail “small”, the synchronizing unit 324 in the smart phone 3 reduces the short side of the original photograph to 250 pixels while maintaining the aspect ratio of the original photograph and determines whether the long side is equal to or less than 1024 pixels. If the determination result indicates that the long side is equal to or less than 1024 pixels, the synchronizing unit 324 sets, as the thumbnail “small”, the photograph whose short side is reduced to 250 pixels. In contrast, if the long side is not equal to or less than 1024 pixels, the synchronizing unit 324 sets, as the thumbnail “small”, the photograph whose long side is reduced to 1024 pixels while maintaining the aspect ratio of the photograph. The thresholds 1024 and 250 that are used when the thumbnail “small” is created are only examples and other values may also be used as the thresholds.

The individual synchronizing unit 327 performs, for each note, data synchronization with the cloud system 1. Namely, for the note whose note ID has been specified, the individual synchronizing unit 327 performs the data synchronization including a photograph and the thumbnail “medium”.

The device determining unit 328 determines whether the own device is the PC 2 or the smart phone 3. The device determining unit 328 determines whether the own device is the PC 2 or the smart phone 3 by using, for example, the CPU performance, the communication performance, or the storage capacity of the own device.

Furthermore, if the own device is the smart phone 3, the device determining unit 328 further determines whether a Wi-Fi connection is available. If the determination result indicates that the Wi-Fi connection is available, the device determining unit 328 further compares the contract capacity of the cloud storage with the capacity of the local storage. The contract capacity of the cloud storage mentioned here is the contract capacity of storage for the cloud system 1 and the capacity of the local storage is the storage capacity of the own device that stores therein photographs that have been subjected to data synchronization.

The control unit 329 performs the overall control of the storage service using unit 32. Specifically, the control unit 329 moves control between functioning units, exchange data between the functioning units and a storing unit, or the like.

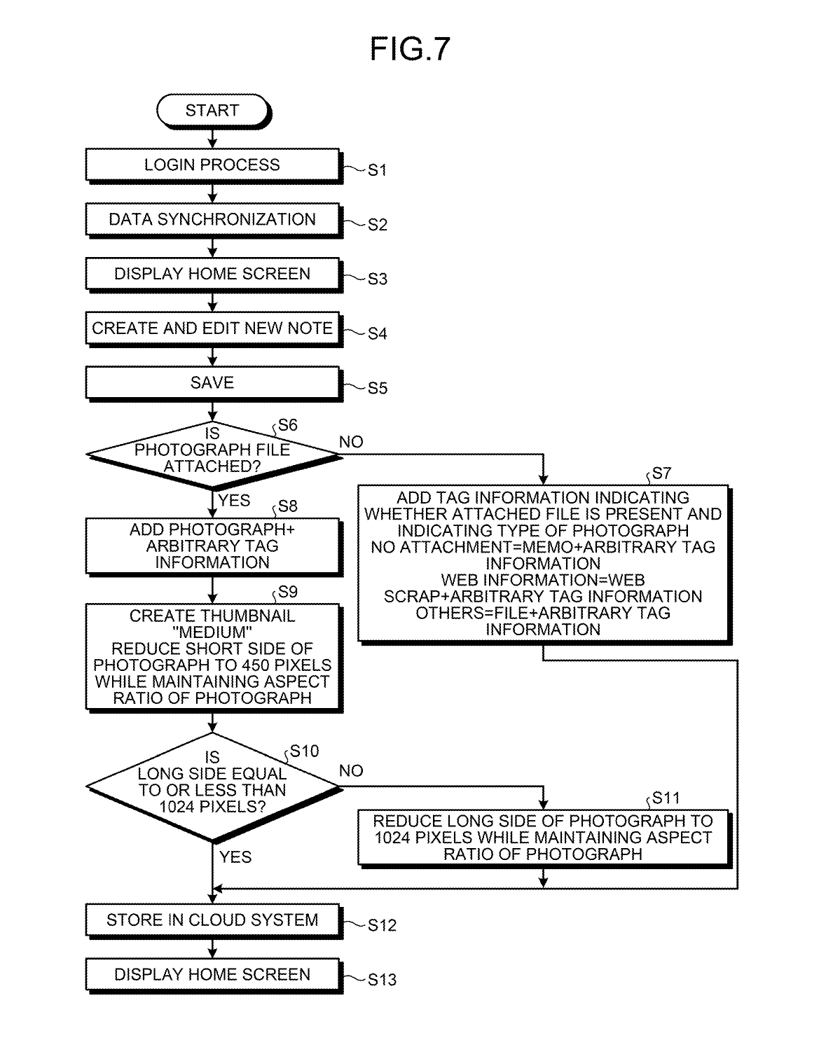

In the following, the flow of an uploading process from a client to the cloud system 1 will be described. The client mentioned here is the PC 2 or the smart phone 3. FIG. 7 is a flowchart illustrating the flow of an uploading process from a client to the cloud system 1.

As illustrated in FIG. 7, in the uploading process, the authentication unit 322 performs a login process (Step S1) and, if authentication is successful, the synchronizing unit 324 performs data synchronization (Step S2). Then, the menu unit 323 displays the home screen (Step S3) and, if a user selects creation/edition of a new note, the editing unit 325 creates and edits the new note in accordance with the instruction from the user (Step S4). Then, the editing unit 325 stores the created or the edited note in the note information storing unit 321 (Step S5).

Then, the upload unit 326 determines whether a photograph file is attached to the created or the edited note (Step S6). If the photograph file is not attached, the upload unit 326 adds tag information indicating whether an attached file is present and indicating the type of photograph to the note (Step S7).

Specifically, if no attached file is present, in addition to arbitrary tag information specified by the user, the upload unit 326 adds a “memorandum” as the tag information. Furthermore, if the attached file is WEB information, in addition to arbitrary tag information specified by the user, the upload unit 326 adds a “WEB scrap” as the tag information. Furthermore, if any other file is attached, in addition to arbitrary tag information specified by the user, the upload unit 326 adds a “file” as the tag information. Then, the upload unit 326 moves to Step S12.

In contrast, if a photograph file is attached, in addition to arbitrary tag information specified by the user, the upload unit 326 adds a “photograph” to the tag information (Step S8).

Then, the upload unit 326 creates the thumbnail “medium” (Step S9). Namely, the upload unit 326 reduces the short side of the photograph to 450 pixels while maintaining the aspect ratio of the photograph and sets the photograph as the thumbnail “medium”. Then, the upload unit 326 determines whether the long side of the reduced photograph is equal to or less than 1024 pixels (Step S10). If the long side is not equal to or less than 1024 pixels, the upload unit 326 reduces the long side to 1024 pixels while maintaining the aspect ratio of the photograph (Step S11) and sets the photograph as the thumbnail “medium”.

Then, the upload unit 326 stores, in the cloud system 1, the information on the created or edited note together with the tag information (Step S12). At this time, if the upload unit 326 creates the thumbnail “medium”, the upload unit 326 also stores the thumbnail “medium” in the cloud system 1. Then, the menu unit 323 displays the home screen (Step S13) and receives a subsequent operation from the user.

As described above, because the upload unit 326 creates the thumbnail “medium” and uploads the created thumbnail together with the original photograph to the cloud system 1, the storage service using unit 32 can perform the thumbnail synchronization using the thumbnail “medium”.

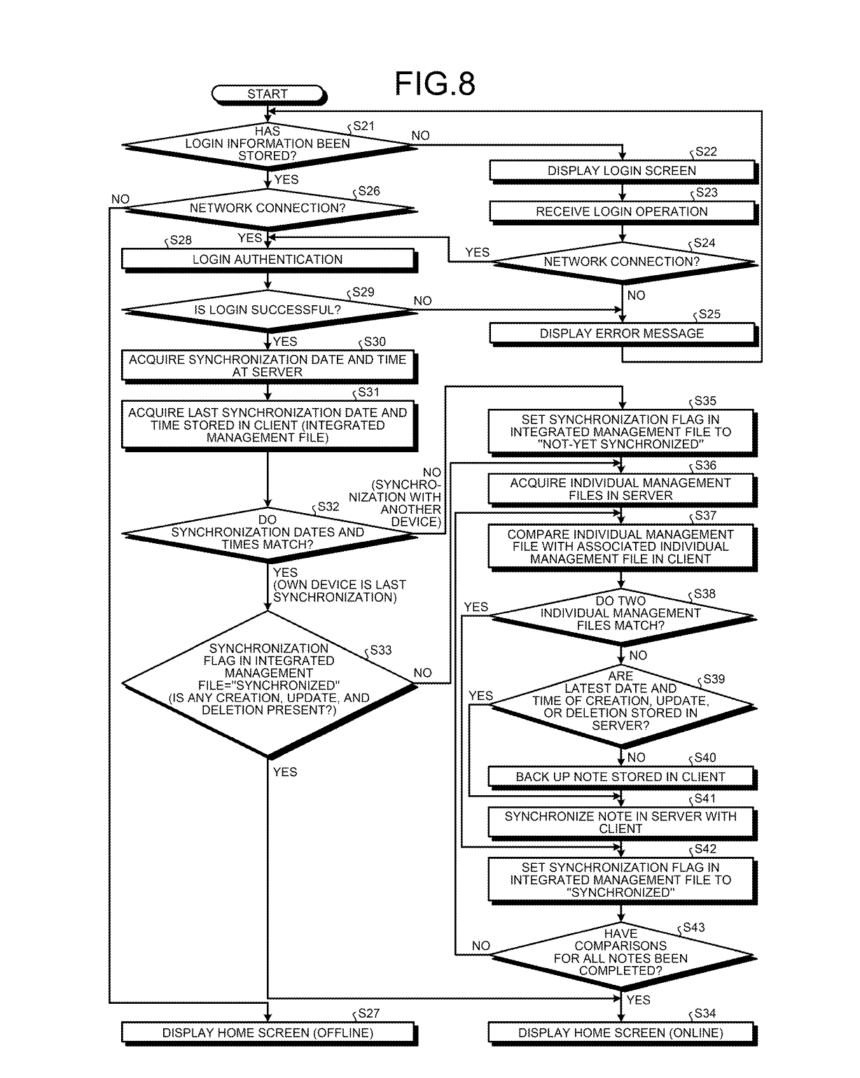

In the following, the flow of a login process and data synchronization will be described in detail. FIG. 8 is a flowchart illustrating the flow of a login process and a process of data synchronization in detail. As illustrated in FIG. 8, the authentication unit 322 determines whether a client stores login information (Step S21). If the client does not store the login information, the authentication unit 322 displays the login screen (Step S22). Then, the authentication unit 322 receives a login operation performed by a user (Step S23) and determines whether the user is connected to the network (Step S24). If the user is connected to the network, the authentication unit 322 moves to Step S28. In contrast, if the user is not connected to the network, the authentication unit 322 displays an error message (Step S25) and returns to Step S21.

In contrast, if the client stores the login information, the authentication unit 322 determines whether the user is connected to the network (Step S26). If the user is not connected to the network, the menu unit 323 displays the home screen (Step S27) and receives an operation performed offline by the user. In contrast, if the user is connected to the network, the authentication unit 322 performs the login authentication (Step S28) and determines whether the login is successful (Step S29). If the login is not successful, the authentication unit 322 moves to Step S25.

In contrast, if the login is successful, the synchronizing unit 324 acquires the synchronization date and time performed in the server (Step S30) and acquires last synchronization date and time stored in the client (Step S31). In the client, last synchronization date and time are stored in the integrated management file as the server synchronization date and time.

Then, the synchronizing unit 324 determines whether the acquired two synchronization dates and times match (Step S32). If both match, this state indicates a case in which the own device performs the last synchronization. Accordingly, the synchronizing unit 324 determines whether the synchronization flag in the integrated management file indicates “synchronized” (Step S33). If the determination result indicates that the synchronization flag in the integrated management is “synchronized”, this state indicates a case in which none of creation, update, and deletion of a note are present in the own device after the last synchronization. Accordingly, the menu unit 323 displays the home screen (Step S34) and receives the operation performed online by the user. In contrast, if the synchronization flag in the integrated management file is not “synchronized”, this state indicates a case in which creation, update, or deletion of a note is present in the own device after the last synchronization. Accordingly, the synchronizing unit 324 moves to Step S36 in order to perform the data synchronization with the cloud system 1.

Furthermore, if the acquired two synchronization date and time do not match, this state indicates a case in which synchronization is performed in another device. Accordingly, the synchronizing unit 324 sets the synchronization flag in the integrated management file to “not-yet synchronized” (Step S35) and performs the data synchronization with the cloud system 1.

Namely, the synchronizing unit 324 acquires the individual management files related to all of the notes in the server (Step S36). Then, the synchronizing unit 324 compares one of the acquired individual management files with the associated individual management file in the client (Step S37) and determines whether these two individual management files match (Step S38). After the determination, if these two individual management files match, data synchronization is not needed for the associated note. Accordingly, the synchronizing unit 324 moves to Step S42.

In contrast, if these two individual management files do not match, the synchronizing unit 324 determines whether the latest date and time from among the creation date and time, the update date and time, and the deletion date and time is present in the server (Step S39). If the latest date and time is not present in the server, it is conceivable that an update is being performed in the own device and thus the synchronizing unit 324 backs up the note stored in the client (Step S40).

Then, the synchronizing unit 324 synchronizes the note in the server with the client (Step S41) and sets the synchronization flag in the integrated management file to “synchronized” (Step S42). Then, the synchronizing unit 324 determines whether comparisons of the individual management files for all of the notes have been completed (Step S43). If the comparison has not been completed, the synchronizing unit 324 returns to Step S37. In contrast, if the comparison of the individual management files for all of the notes has been completed, the menu unit 323 displays the home screen (Step S34) and receives the operation performed online by the user.

As described above, the synchronizing unit 324 backs up a note in a client if the latest date and time from among the creation date and time, the update date and time, and the deletion date and time is not present in the server. Consequently, it is possible to prevent discard of a note that is being edited and that has not subjected to synchronization.

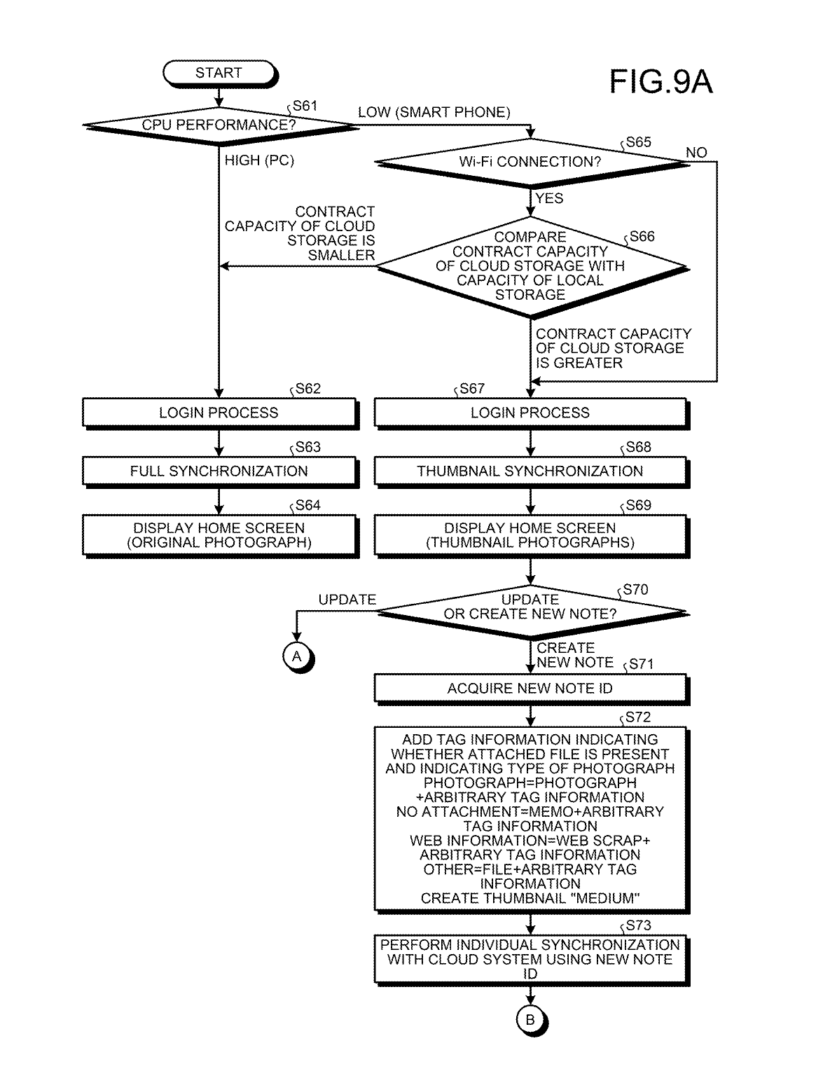

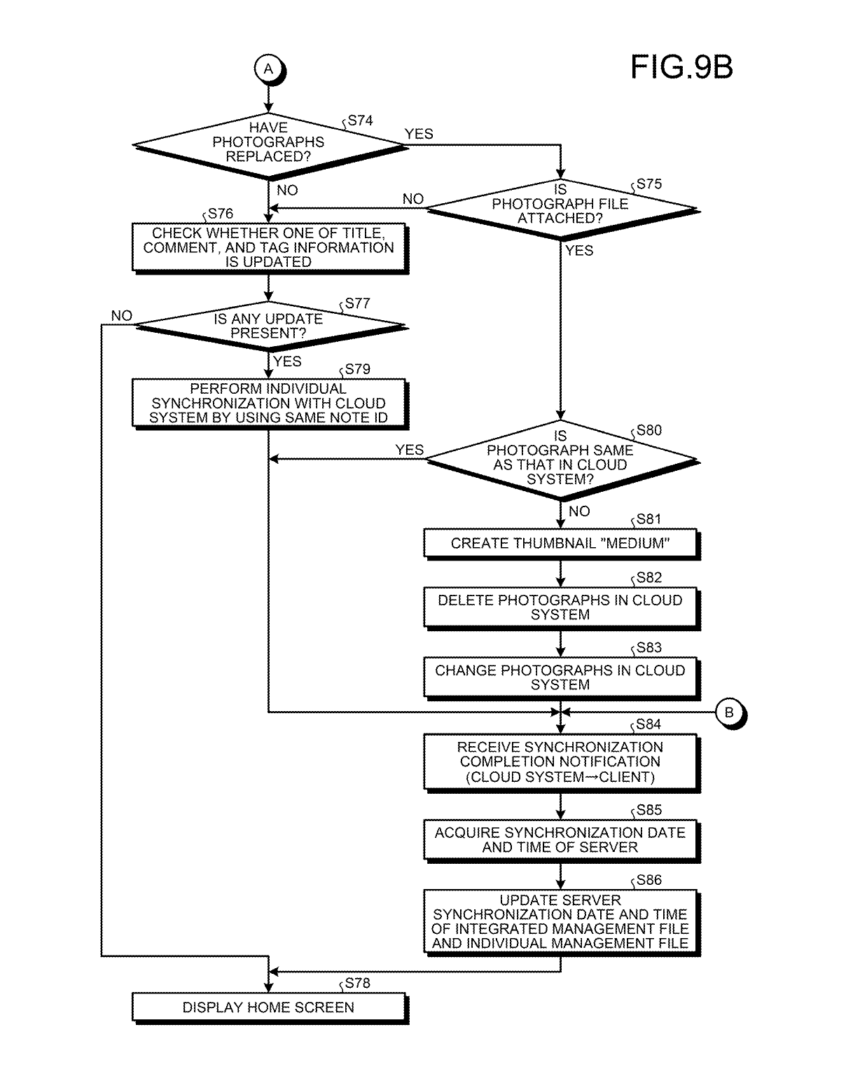

In the following, the flow of a process related to thumbnail synchronization will be described. FIGS. 9A and FIG. 9B are flowcharts each illustrating the flow of a process related to thumbnail synchronization. As illustrated in FIGS. 9A and 9B, the device determining unit 328 determines whether the CPU capacity of the own device is higher than a predetermined level, i.e., determines whether the own device is the PC 2 (Step S61).

If the CPU performance of the own device is higher than a predetermined level, i.e., if the own device is the PC 2, the authentication unit performs the login process (Step S62) and the synchronizing unit performs the full synchronization (Step S63). Then, the menu unit displays the home screen (Step S64) and receives the operation performed online by a user.

In contrast, if the CPU performance of the own device is not higher than a predetermined level, i.e., if the own device is the smart phone 3, the device determining unit 328 determines whether a Wi-Fi connection is available (Step S65). If the determination result indicates that the Wi-Fi connection is available, the device determining unit 328 compares the contract capacity of the cloud storage with the capacity of the local storage (Step S66).

If the determination result indicates that the contract capacity of the cloud storage is smaller, because all of the photographs stored in the cloud system 1 can be stored in the own device, the device determining unit 328 moves to Step S62.

In contrast, if the contract capacity of the cloud storage is greater, because all of the photographs stored in the cloud system 1 are not able to be stored in the own device, the authentication unit 322 performs the login process (Step S67) and the synchronizing unit 324 performs the thumbnail synchronization (Step S68). Then, the menu unit 323 displays the home screen (Step S69) and receives the operation performed online by the user.

Then, if the user selects edition of a note, the editing unit 325 determines whether the operation performed by the user indicates whether the note is updated or newly created (Step S70). If the determination result indicates the note is newly created, the editing unit 325 acquires a new note ID (Step S71) and receives a creation operation of the note from the user. If the user ends the creation of the note, the individual synchronizing unit 327 adds tag information indicating whether an attached file is present and indicating the type to the note (Step S72).

Specifically, if a photograph file is attached, in addition to arbitrary tag information specified by the user, the individual synchronizing unit 327 adds a “photograph” as the tag information. Furthermore, if a photograph file is not attached, in addition to arbitrary tag information specified by the user, the individual synchronizing unit 327 adds a “memorandum” as the tag information. Furthermore, if the attached file is WEB information, in addition to arbitrary tag information specified by the user, the individual synchronizing unit 327 adds a “WEB scrap” as the tag information. Furthermore, if any other file is attached, in addition to arbitrary tag information specified by the user, the individual synchronizing unit 327 adds a “file” as the tag information. Furthermore, if a photograph file is attached, the individual synchronizing unit 327 creates the thumbnail “medium”.

Then, the individual synchronizing unit 327 performs individual synchronization with the cloud system 1 by using the new note ID (Step S73) and moves to Step S84.

In contrast, if it is determined that the operation indicates an update of the note, the editing unit 325 receives an update operation of the note from the user. Then, if the user ends the update of the note, the individual synchronizing unit 327 determines whether the update is a replacement of photographs (Step S74).

If the determination result indicates that the update is a replacement of the photographs, the individual synchronizing unit 327 determines whether a photograph file is attached (Step S75). If the determination result indicates that no photograph file is attached, or, indicates that the update is not the replacement of photographs, the individual synchronizing unit 327 checks whether one of the title, the comment, and the tag information is updated (Step S76).

Then, the individual synchronizing unit 327 determines whether an update is present (Step S77). If no update is present, because data synchronization is not needed, the menu unit 323 displays the home screen (Step S78) and receives an operation online by a user. In contrast, if an update is present, the individual synchronizing unit 327 performs individual synchronization with the cloud system 1 by using the same note ID as that used to update the note (Step S79) and moves to Step S84.

Furthermore, if a photograph file is attached, the individual synchronizing unit 327 determines whether the replaced photograph is the same photograph in the cloud system 1 (Step S80). If both are the same, the individual synchronizing unit 327 moves to Step S84. Note that, the individual synchronizing unit 327 determines whether the replaced photograph is the same photograph as that in the cloud system 1 by using the attached file information in the individual management file.

In contrast, if the replaced photograph is not the same photograph as that in the cloud system 1, the individual synchronizing unit 327 creates the thumbnail “medium” (Step S81) and deletes the photographs in the cloud system 1 including the thumbnail “medium” (Step S82). Then, the individual synchronizing unit 327 changes the photographs in the cloud system 1 to the replaced photographs including the thumbnail “medium” (Step S83). In this example, the individual synchronizing unit 327 changes the photographs in the cloud system 1 to the replaced photographs after deleting the photographs including the thumbnail “medium”. However, the individual synchronizing unit 327 may also update the photographs in the cloud system 1 including the thumbnail “medium” at a time.

Then, the individual synchronizing unit 327 receives a synchronization completion notification sent from the cloud system 1 to the client (Step S84) and acquires the synchronization date and time of the server from the cloud system 1 (Step S85).

Then, the individual synchronizing unit 327 updates the server synchronization date and time of the integrated management file and the individual management file (Step S86) and the menu unit 323 displays the home screen (Step S78) and receives an operation performed online by a user.

As described above, if a photograph attached to a note is replaced, the individual synchronizing unit 327 changes the photographs in the cloud system 1 to the replaced photographs including the thumbnail “medium”, thereby the smart phone 3 can update the photographs including the thumbnail “medium”.

In this example, if the own device is the smart phone 3, if a Wi-Fi connection is available, and if the contract capacity of the cloud storage is greater than the capacity of the local storage, the smart phone 3 performs the thumbnail synchronization. However, if the own device is the smart phone 3, the smart phone 3 may also always perform the thumbnail synchronization. Furthermore, if the own device is the smart phone 3 and a Wi-Fi connection is available, the smart phone 3 may also perform the thumbnail synchronization. Furthermore, if the own device is the smart phone 3 and the contract capacity of the cloud storage is greater than the capacity of the local storage, the smart phone 3 may also perform the thumbnail synchronization.

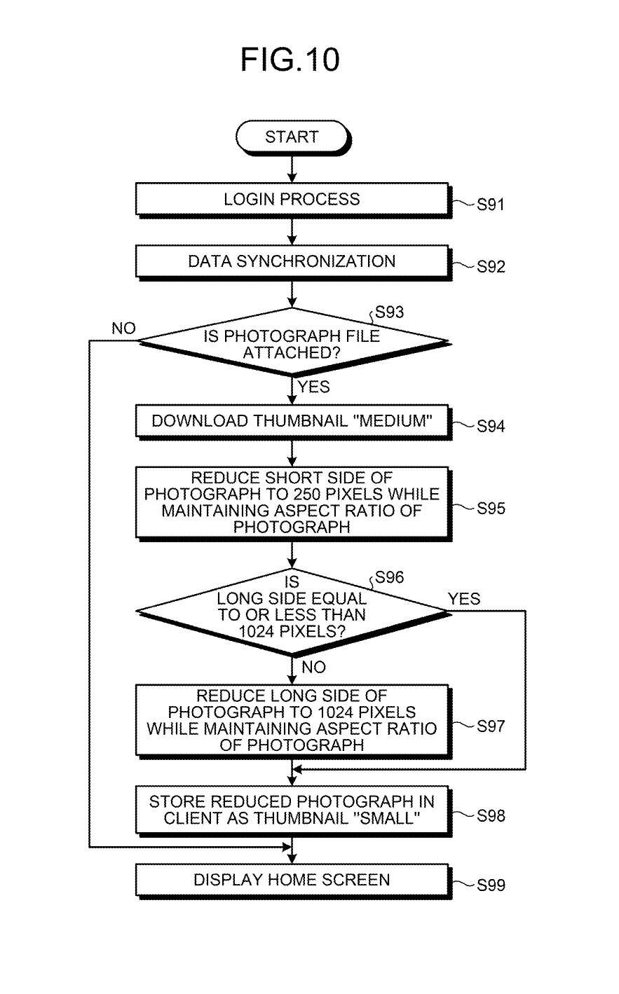

In the following, the flow of a process of creating a thumbnail “small” performed when the thumbnail synchronization is performed. FIG. 10 is a flowchart illustrating the flow of a process of creating a thumbnail “small” performed when thumbnail synchronization is performed.

As illustrated in FIG. 10, the authentication unit 322 performs a login process (Step S91) and the synchronizing unit 324 performs the data synchronization (Step S92). Specifically, the synchronizing unit 324 performs the thumbnail synchronization. Then, the synchronizing unit 324 determines whether a photograph file is attached to the note subjected to the synchronization (Step S93).

If the determination result indicates that the photograph file is not attached, the menu unit 323 displays the home screen (Step S99) and receives an operation performed online by a user. In contrast, if a photograph file is attached, the synchronizing unit 324 downloads the thumbnail “medium” in order to acquire the latest thumbnail “medium” (Step S94) and reduces the short side of the photograph to 250 pixels while maintaining the aspect ratio of the photograph (Step S95).

Then, the synchronizing unit 324 determines whether the long side is equal to or less than 1024 pixels (Step S96). If the long side is not equal to or less than 1024 pixels, the synchronizing unit 324 reduces the long side of the photograph to 1024 pixels while maintaining the aspect ratio (Step S97).

Then, the synchronizing unit 324 stores the reduced photograph in the client (Step S98). Then, the menu unit 323 displays the home screen (Step S99) and receives an operation performed online by the user.

As described above, the synchronizing unit 324 creates the thumbnail “small” from the thumbnail “medium” and stores the thumbnail “small” in the smart phone 3, thereby an arbitrary application running in the smart phone 3 can use the thumbnail “small”.

As described above, in the embodiment, the device determining unit determines whether the own device is the PC 2 or the smart phone 3. If the device determining unit determines that the own device is the PC 2, the synchronizing unit performs the full synchronization, whereas, if the device determining unit determines that the own device is the smart phone 3, the synchronizing unit essentially performs the thumbnail synchronization. Consequently, in a case in which the number of photographs uploaded from the PC 2 is great, it is possible to suppress the occurrence of a problem in the data synchronization between the smart phone 3 and the cloud system 1 due to the processing performance, communication performance, a lack of storage capacity of the smart phone 3.

Furthermore, in the embodiment, because, when the client uploads a photograph to the cloud system 1, the client creates the thumbnail “medium” from the original photograph and sends the created thumbnail together with the original photograph to the cloud system 1, it is possible to reduce the processing load in the server in the cloud system 1.

Furthermore, in the embodiment, when the client creates the thumbnail “medium”, if one side of a photograph is excessively longer than the other side, the client reduces the long side to a predetermined threshold while maintaining the aspect ratio. Consequently, the client can suppress the size of the thumbnail “medium” even if one side of the photograph is excessively longer than the other side.

Furthermore, in the embodiment, if the smart phone 3 updates a photograph that has been subjected to synchronization with the cloud system 1, the smart phone 3 deletes the photographs stored in the cloud system 1 together with the thumbnail “medium” and changes to the updated photographs together with the thumbnail “medium”. Accordingly, the smart phone 3 can update the photographs in the cloud system 1 including the thumbnail “medium”.

Furthermore, in the embodiment, because the smart phone 3 creates the thumbnail “small” from the thumbnail “medium” and stores the thumbnail “small” in the smart phone 3, an arbitrary application running in the smart phone 3 can use the thumbnail “small”.

Furthermore, in the embodiment, the storage service using unit has been described; however, it is possible to obtain a storage service use program having the same function as that performed by the storage service using unit by implementing the configuration of the storage service using unit by using software. Accordingly, the hardware configuration of each of the smart phone and the PC that performs the storage service use program will be described.

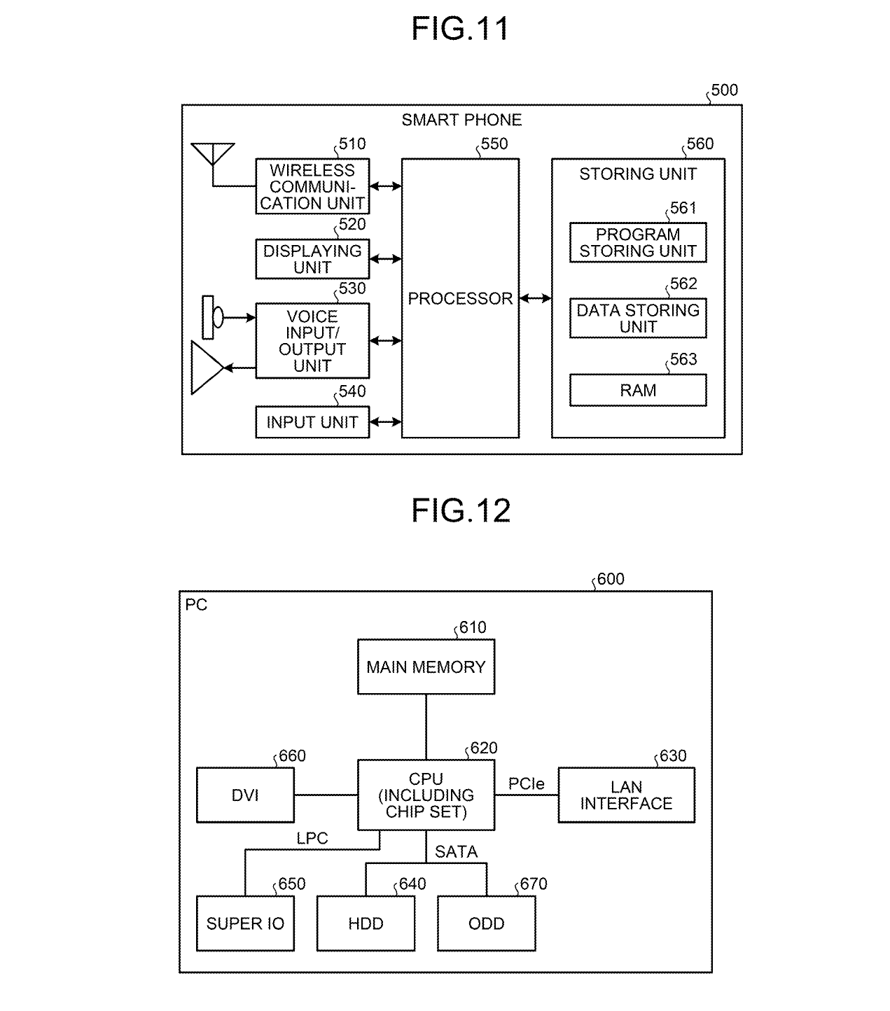

FIG. 11 is a block diagram illustrating the hardware configuration of the smart phone. As illustrated in FIG. 11, a smart phone 500 includes a wireless communication unit 510, a displaying unit 520, a voice input/output unit 530, an input unit 540, a processor 550, and a storing unit 560. The wireless communication unit 510, the displaying unit 520, the voice input/output unit 530, the input unit 540, and the storing unit 560 are connected to the processor 550.

The wireless communication unit 510 performs wireless voice communication or data communication with another smart phone, a mobile phone, a fixed line phone, a computer that is set up by a mobile phone service provider, or the like. Furthermore, the wireless communication unit 510 performs communication with an access point by using a wireless LAN.

The displaying unit 520 is a liquid crystal display device that displays a screen that is output by a program, such as the storage service use program. The voice input/output unit 530 includes a microphone that inputs voice and includes a speaker that outputs the voice. The input unit 540 inputs the data specified by a user via the liquid crystal display device.

The storing unit 560 includes a program storing unit 561, a data storing unit 562, and a random access memory (RAM) 563. The program storing unit 561 stores therein a program, such as a storage service use program or the like, that implements the function performed by the storage service using unit 32 illustrated in FIG. 4. The data storing unit 562 stores therein various kinds of data, such as the individual management file, the integrated management file, or the like stored in the note information storing unit 321 illustrated in FIG. 4. The storing unit 560 is, for example, a semiconductor memory device, such as a flash memory and the like, or a storage device, such as a hard disk device, and the like.

The processor 550 is, for example, an electronic circuit, such as a central processing unit (CPU), a micro processing unit (MPU), or the like. The processor 550 reads the storage service use program from the program storing unit 561 and loads the storage service use program in the RAM 563, thus executing the storage service use program.

FIG. 12 is a block diagram illustrating the hardware configuration of the PC. As illustrated in FIG. 12, a PC 600 includes a main memory 610, a CPU 620, a LAN interface 630, an HDD 640, a super IO 650, a digital visual interface (DVI) 660, and an optical disk drive (ODD) 670.

The main memory 610 is a memory that stores therein a program or the in-execution result of the program. The CPU 620 is a central processing unit that reads the program from the main memory 610 and executes the program. The CPU 620 includes a chip set including a memory controller.

The LAN interface 630 is an interface for connecting the PC 600 to another computer via a LAN. The HDD 640 is a disk device that stores therein the program or data. The super IO 650 is an interface for connecting an input device, such as the mouse, a keyboard, or the like. The DVI 660 is an interface for connecting a liquid crystal display device and the ODD 670 is a device that reads and writes the DVD.

The LAN interface 630 is connected to the CPU 620 by a PCI express. The HDD 640 and the ODD 670 are connected to the CPU 620 by a serial advanced technology attachment (SATA). The super IO 650 is connected to the CPU 620 by the low pin count (LPC).

The storage service use program executed by the PC 600 is stored in the DVD, is read from the DVD by the ODD 670, and is then installed in the PC 600. Alternatively, the storage service use program is stored in databases in another computer system that is connected via the LAN interface 630, is read from the databases, and is then installed in the PC 600. Then, the installed storage service use program is stored in the HDD 640, is read into the main memory 610, and is then executed by the CPU 620.

Furthermore, in the embodiment, a description has been given of a case in which data synchronization is performed on photographs as the target; however, the storage service using unit can also similarly perform data synchronization on another kind of data other than photographs, such as images, WEB information, music, documents, or the like.

Furthermore, in the embodiment, a description has been given of a case in which the data synchronization is performed by using thumbnails of the photographs; however, the present invention is not limited thereto. For example, the present invention may also be used for a case in which the data synchronization is performed by using the opening notes of music, the beginning part of a document, or the like.

According to an aspect of an embodiment of the present invention, an advantage is provided in that it is possible to suppress the occurrence of a problem when data synchronization is performed, by a cloud system, with various types of information terminal devices.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information terminal device comprising:
a determining unit that determines whether an own device has capability to perform data synchronization, by using original data, with a service providing apparatus that provides a storage service for storing, together with the original data, reduced data whose size is reduced to equal to or less than the size of the original data; and
a synchronizing unit that performs, when the determining unit determines that the own device does not have the capability, data synchronization with the service providing apparatus by using the reduced data.

2. The information terminal device according to claim 1, further comprising:
a reducing unit that reduces the size of the original data and that creates the reduced data; and
an upload unit that uploads the original data and the reduced data to the service providing apparatus.

3. The information terminal device according to claim 2, wherein
the data is photograph data, and
the reducing unit creates, when the short side of a photograph is reduced to a first pixel value and when the long side of the photograph reduced by maintaining the aspect ratio does not exceed a second pixel value, a reduced photograph by maintaining the aspect ratio and by reducing the short side to the first pixel value and, when the short side of the photograph is reduced to the first pixel value and when the long side of the photograph reduced by maintaining the aspect ratio exceeds the second pixel value, a reduced photograph by maintaining the aspect ratio and by reducing the long side to the second pixel value.

4. The information terminal device according to claim 3, further comprising:
a reduced photograph reducing unit that further reduces the reduced photograph; and
a storing unit that stores, in a storage device, the photograph reduced by the reduced photograph reducing unit.

5. The information terminal device according to claim 1, wherein the determining unit determines, on the basis of processing performance, communication performance, and data storage capacity, whether the own device has the capability.

6. A storage service use method comprising:
determining, performed by a computer, whether an own device has capability to perform data synchronization, using original data, with a service providing apparatus that provides a storage service for storing, together with the original data, reduced data whose size is reduced to equal to or less than the size of the original data; and
performing, performed by the computer, when it is determined that the own device does not have the capability, data synchronization with the service providing apparatus by using the reduced data.

7. A computer-readable recording medium having stored therein a program that causes a computer to execute a process comprising:
determining whether an own device has the capability to perform data synchronization, by using original data, with a service providing apparatus that provides a storage service for storing, together with the original data, reduced data whose size is reduced to equal to or less than the size of the original data; and
performing, when it is determined that the own device does not have the capability, data synchronization with the service providing apparatus by using the reduced data.
